(19) United States
(12) Patent Application Publication
(10) Pub. No.: US 2012/0097140 A1
(43) Pub. Date: Apr. 26, 2012

(54) CONTROL METHOD AND SPARK PLUG FOR SPARK -IGNITED INTERNAL COMBUSTION ENGINE

(75) Inventors: Ryouhei Kusunoki, Osaka (JP); Takeshi Serizawa, Osaka (JP); Morito Asano, Osaka (JP); Hiroaki Oi, Osaka (JP)

(73) Assignee: DAIHATSU MOTOR CO., LTD., Osaka (JP)

(21) Appl. No.: 13/379,545

(22) PCT Filed: Sep. 24, 2009
(86) PCT No.: PCT/JP2009/066487

§ 371 Date: Dec. 20, 2011

(30) Foreign Application Priority Data
Jun. 29, 2009 (JP) 2009-154256
Jun. 29, 2009 (JP) 2009-154263

(51) Int. Cl. F02P 3/02; H01T 13/20

(52) U.S. Cl. 123/620; 313/141

(57) ABSTRACT

A control method for a spark-ignited internal combustion engine includes generating plasma by interacting an electric field generated in a combustion chamber by electric field generation means with spark discharge caused by a spark plug, and igniting an air-fuel mixture, wherein the electric field generated by the electric field generation means is set to an intensity weaker than that of an electric field generated by the spark plug when the spark discharge is caused, and set to an intensity at which discharge into the combustion chamber is disabled, and the air-fuel mixture can be securely ignited and combusted at an intended ignition timing and at a position of the spark plug.

### TECHNICAL FIELD

The present invention relates to a control method and a spark plug for a spark-ignited internal combustion engine for igniting an air-fuel mixture by generating plasma through interaction between an electric field generated in a combustion chamber and spark discharge caused by a spark plug.

### BACKGROUND ART

Conventionally, in a spark-ignited internal combustion engine mounted in a vehicle, in particular, an automobile, an air-fuel mixture in a combustion chamber is ignited at each ignition timing by spark discharge between a center electrode and a ground electrode of a spark plug. According to such ignition by the spark plug, ignition fails in rare cases, for example, in an internal combustion engine of a type of injecting fuel directly into a cylinder, unless the injected fuel is distributed in a position where the spark discharge by the spark plug takes place.

Accordingly, the spark discharge by the spark plug is supplemented in such an internal combustion engine. For example, there is known an arrangement as described in Patent Document 1, in which a plasma atmosphere is generated in a discharge area of the spark plug, arc discharge is caused in the plasma atmosphere so that the air-fuel mixture in the combustion chamber is securely ignited without applying a high voltage as compared with a conventional system, and a stable flame can be obtained.

### PRIOR ART DOCUMENT

### Patent Document

Patent Document 1: Japanese Unexamined Patent Publication No. 2007-32349

### SUMMARY OF THE INVENTION

### Problems to be Solved by the Invention

Meanwhile, there is considered a method of using a magnetron as a method to generate plasma under the atmospheric pressure. When plasma is generated in the combustion chamber using the magnetron, it is necessary to provide an electrode such as an auxiliary electrode described in Patent Document 1, that is, an antenna, which radiates microwaves from the magnetron to the spark plug or its periphery.

In such cases, if, for example, an output of the magnetron is increased according to a size of load of the internal combustion engine, discharge may be caused between the antenna and an inner wall of the combustion chamber. The antenna is originally purposed for forming a high-frequency electric field to generate plasma in the combustion chamber. In such an antenna, if discharge is caused prior to the discharge by the spark plug, it is highly possible to ignite the air-fuel mixture at an unintended timing. Since this results in the ignition and combustion different from those at the originally intended ignition timing, and a necessary torque may not be obtained.

On the other hand, in the case where the center electrode of the spark plug is caused to function as the antenna, an intensity of high-frequency electric field required for generation of plasma may not be generated if an output of the magnetron is set low. In other words, an ordinary spark plug has a structure in which the ground electrode having substantially a rectangular shape in cross section is provided immediately below the center electrode with a gap provided therebetween. With such an electrode structure, when a microwave is applied to the center electrode, a direction of the high-frequency electric field caused by the microwave is directed in an axial direction of the center electrode.

However, if the direction of the high-frequency electric field becomes identical to the axial direction of the center electrode, that is, a discharge direction of the spark discharge, the action exerted on the spark discharge by the high-frequency electric field becomes smaller, and the effect as originally intended cannot be expected.

In view of this, it is an object of the present invention to solve such a drawback.

### Means for Solving the Problems

Specifically, a control method for a spark-ignited internal combustion engine of a first aspect of the present invention includes: generating plasma by interacting an electric field generated in a combustion chamber by electric field generation means with spark discharge caused by a spark plug; and igniting an air-fuel mixture, wherein the electric field generated by the electric field generation means is set to an intensity weaker than that of an electric field generated by the spark plug when the spark discharge is caused and is set to an intensity at which discharge into the combustion chamber is disabled.

According to such a configuration, the intensity of the electric field generated by the electric field generation means is lower than that of the electric field generated by the spark plug, and is such an intensity at which discharge into the combustion chamber is disabled. Accordingly, no discharge other than the spark discharge of the spark plug is caused while the electric field is generated. As a result, it is possible to suppress accidental ignition of the compressed air-fuel mixture at a timing other than the ignition timing.

Examples of the electric field generation means that generates an electric field include an electromagnetic wave generation device that generates an electromagnetic wave of various frequencies, an alternating voltage generation device that applies an alternating voltage to a pair of electrodes disposed in the combustion chamber, and a pulsation voltage generation device that similarly applies a pulsation voltage to the pair of electrodes.

The electromagnetic wave generated by the electromagnetic wave generation device includes a microwave, a high-frequency wave including a frequency used in various radio communications such as amateur radio, or the like.

The alternating voltage outputted by the alternating voltage generation device has a frequency identical to the above-mentioned high frequency.

The pulsation voltage generation device may be such a device that generates a direct voltage whose voltage periodically changes, and a waveform of the direct voltage may take an arbitrary form. In other words, the pulsation voltage according to the present invention includes a pulse voltage in which a voltage changes at constant intervals from a reference voltage including 0 volts to a certain voltage, a direct voltage that sequentially increases and decreases to a voltage at constant intervals, for example, a waveform such as the one resulting from performing half-wave rectification on an alternating voltage, further a direct voltage resulted from applying a DC bias to an alternating voltage, and the like. In this case, the constant interval may be such an interval that corresponds to the frequency of the above-mentioned high-frequency wave. The waveform is not limited to those described above, and may be a sinusoidal waveform, a sawtooth waveform, a triangular waveform, or the like.

Further, a control method for a spark-ignited internal combustion engine according to a fourth aspect of the present invention includes: generating plasma by interacting an electric field generated in a combustion chamber by laser with spark discharge caused by a spark plug; and igniting an air-fuel mixture, wherein when the electric field is generated by the laser, energy of the laser is set to a level at which ignition is disabled.

The laser may be configured to be generated by a laser oscillation device that can change an output and directed into the combustion chamber through an optical fiber.

The spark plug for a spark-ignited internal combustion engine according to a sixth aspect of the present invention includes a center electrode electrically insulated and attached in a housing, and a ground electrode arranged at a lower end of the housing away from the center electrode, in which plasma is generated by interacting spark discharge caused between the center electrode and the ground electrode with an electric field generated in a combustion chamber, and an air-fuel mixture is ignited. The ground electrode is disposed so that a front end thereof is positioned away from a center axis of the center electrode, and the ground electrode includes a specific surface that forms a direction of the electric field in a direction intersecting a direction of the spark discharge that is caused between the center electrode and the ground electrode.

According to such a configuration, when the electric field interacts with the spark discharge, the electric field is formed by the specific surface in a direction intersecting the spark discharge. Accordingly, the interaction between the electric field and the spark discharge becomes excellent, and by generating the plasma intensively and efficiently in a space between the center electrode and the specific surface, the spark discharge is amplified for excellent ignition. As a result, the energy for generating the electric field can be reduced, and it is possible to prevent discharge from being caused by the energy for generating the electric field prior to the normal spark discharge between the center electrode and the ground electrode.

Specifically, the specific surface may include an inclined surface provided on a lower surface of the ground electrode on a side opposite to the center electrode. For forming the direction of the electric field in a desired direction in such a configuration, it is preferable that the ground electrode include an inclined side surface that obliquely crosses an extended axial line of the ground electrode intersecting the center axis of the center electrode.

When this type of spark plug is used, the above-mentioned electric field generation means may be taken as the above-mentioned means for generating the electric field.

### Effects of the Invention

According to the first aspect of the present invention configured as described above, by suppressing the discharge by means of the electric field generation means for generating the electric field, and according to the fourth aspect of the present invention, by setting the laser energy to a level at which ignition is disabled, the air-fuel mixture can be securely ignited and combusted at an intended ignition timing and at a position of the spark plug.

Further, according to the sixth aspect of the present invention configured as described above, the interaction between the electric field and the spark discharge becomes excellent, and by generating the plasma intensively and efficiently in the space between the center electrode and the specific surface, the spark discharge is amplified for excellent ignition. As a result, it is possible to reduce the energy for generating the electric field, and prevent discharge from being caused by the energy for generating the electric field prior to the spark discharge between the center electrode and the ground electrode.

### BRIEF DESCRIPTION OF THE DRAWINGS

FIG. 1 is an explanatory diagram illustrating a schematic configuration of a first embodiment according to the present invention.

FIG. 2 is a flowchart illustrating a control procedure of the first embodiment according to the present invention.

FIG. 3 is a block diagram illustrating a configuration of an electromagnetic wave generation device that can be used in the first embodiment according to the present invention.

FIG. 4 is a block diagram illustrating a configuration of an alternating voltage generation device that can be used in the first embodiment according to the present invention.

FIG. 5 is a circuit diagram illustrating one example of an H-bridge circuit illustrated in FIG. 4.

FIG. 6 is a block diagram illustrating a configuration of a pulsation generating device that can be used in the first embodiment according to the present invention.

FIG. 7 is a block diagram illustrating a configuration of a laser oscillation device that can be used in a second embodiment according to the present invention.

FIG. 8 is cross-sectional view illustrating an enlarged view of a principal portion of an engine applied to a third embodiment according to the present invention.

FIG. 9 is a front view of the third embodiment according to the present invention.

FIG. 10 is an enlarged front view of a principal portion of the third embodiment according to the present invention.

FIG. 11 is a bottom view of the third embodiment according to the present invention.

FIG. 12 is an enlarged perspective view of a principal portion of the third embodiment according to the present invention.

### EMBODIMENTS FOR CARRYING OUT THE INVENTION

A first embodiment of the present invention will be described below with reference to the drawings.

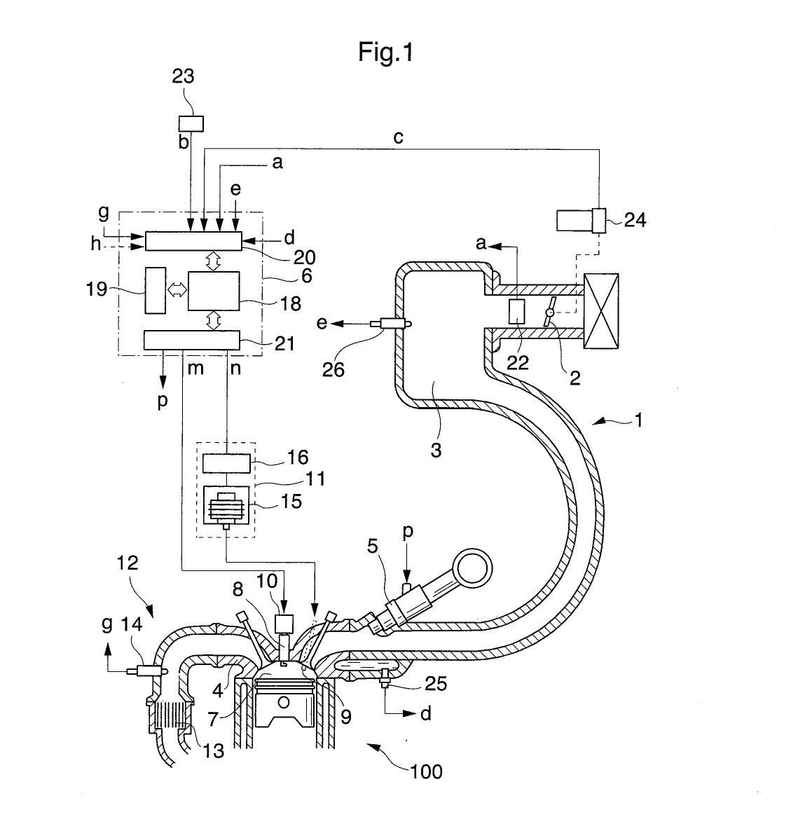

An engine 100 whose configuration of one cylinder is schematically illustrated in FIG. 1 is of a three-cylinder engine for an automobile. A throttle valve 2 which opens and closes in response to an accelerator pedal (not illustrated) is provided in an intake system 1 of the engine 100, and a surge tank 3 is provided downstream from the throttle valve 2. Further, a fuel injection valve 5 is provided in the vicinity of an end portion on a side of a cylinder head 4 with which the surge tank 3 communicates, and the fuel injection valve 5 is configured to be controlled by an electronic control device 6. To a ceiling portion of the combustion chamber 7, there is attached an antenna 9 which constitutes, together with a spark plug 8 and a microwave generation device 11 which will be described later, electric field generation means for generating an electric field in a combustion chamber 7. The antenna 9 according to this embodiment is a monopole antenna and attached to a position in the vicinity of the spark plug 8 in the ceiling portion of the combustion chamber 7. An ignition coil 10 provided integrally with an igniter is attached to the spark plug 8 in a replaceable manner. The antenna 9 has a rod-like shape, is attached to a wall of the combustion chamber 7 through an insulator, and protrudes into the combustion chamber 7. The antenna 9 is connected to the microwave generation device 11 through a waveguide and a coaxial cable (which are not illustrated). A three-way catalyst (hereinafter, referred to as “catalyst 13”) is provided in a conduit line leading to a muffler (not illustrated) of an exhaust system 12, and an O₂ sensor 14 is attached at an upstream side of the catalyst 13.

The microwave generation device 11, which is an electromagnetic wave generation device, is provided with a magnetron 15 and a control circuit 16 for controlling the magnetron 15. A microwave outputted from the magnetron 15 is applied to the antenna 9 by means of the waveguide and the coaxial cable. The control circuit 16 is configured to receive a microwave generation signal n outputted from the electronic control device 6, and controls an output timing and output power of the microwave outputted from the magnetron 15 based on the microwave generation signal n that is inputted thereto.

The electronic control device 6 is mainly configured of a microcomputer system that includes a central processing unit 18, a memory device 19, an input interface 20, and an output interface 21. The central processing unit 18 performs operation control of the engine 100 by executing a program, which is described later, stored in the memory device 19.

Then, information required for performing the operation control of the engine 100 is inputted to the central processing unit 18 through the input interface 20, and the central processing unit 18 outputs a signal for controlling to the fuel injection valve 5 or the like through the output interface 21. Specifically, the input interface 20 receives, as input, an intake pressure signal a outputted from an intake pressure sensor 22 for detecting a pressure of an intake air, a rotation speed signal b outputted from a rotation speed sensor 23 for detecting an engine rotation speed, an IDL signal c outputted from an idling switch 24 for detecting an open and close state of the throttle valve 2, a water temperature signal d outputted from a water temperature sensor 25 for detecting a cooling water temperature of the engine 100, an intake temperature signal e outputted from an intake temperature sensor 26 for detecting a temperature of new air inhaled by the engine 100, a voltage signal f outputted from the O₂ sensor 14 for detecting an oxygen concentration in an exhaust gas exhausted from the combustion chamber 7 through an exhaust valve, and the like. Meanwhile, the output interface 21 is configured to output a fuel injection signal p to the fuel injection valve 5, an ignition signal m to the igniter 10, a microwave generation signal n to the microwave generation device 11, and the like.

The electronic control device 6 has a program incorporated therein. Based on the intake pressure signal a outputted from the intake pressure sensor 22 and the rotation speed signal b outputted from the rotation speed sensor 23 as main information, the program is used to determine an opening time of the fuel injection valve 5, i.e., a final energizing time of the injector, by compensating a basic injection time with various compensation coefficients which are decided depending on an operation condition of the engine 100, control the fuel injection valve 5 according to the energizing time thus determined, and inject the fuel in accordance with the engine load from the fuel injection valve 5 into the intake system 1.

The engine 100 is configured to radiate the microwave generated by the microwave generation device 11 into the combustion chamber 7 from the antenna 9 in synchronization with the output time in a normal operation condition after startup, and generate plasma by interacting the electric field generated by the radiation with the spark discharge caused by the spark plug 8 so that the air-fuel mixture is ignited. The electric field may be generated simultaneously with the start of spark discharge, immediately after the start of spark discharge, or immediately before the start of spark discharge. When the plasma is generated, the electric field is formed in a direction perpendicular to the spark discharge by the spark plug 8 in the combustion chamber 7 by applying the microwave to the antenna 9. The time immediately after the start of spark discharge preferably coincides with the time when induction discharge for forming the spark discharge is started at the latest.

Specifically, the spark discharge by the spark plug 8 turns into the plasma in the electric field. By igniting the air-fuel mixture by the plasma, a flame kernel serving as a start of flame propagation combustion becomes larger as compared with the ignition with only the spark discharge, and the combustion is accelerated by generation of a large amount of radicals in the combustion chamber 7.

This is because flows of electrons by the spark discharge and ions or radicals generated by the spark discharge have a longer path by vibrating and meandering under the influence of the electric field, and a frequency of collision with surrounding water molecules or nitrogen molecules drastically increases.

The water molecules or nitrogen molecules against which the ions or radicals have collided transform into OH radicals or N radicals, and surrounding gasses against which the ions or radicals have collided transform into an ionization state, i.e., a plasma state, which drastically increases an ignition area of the air-fuel mixture and also increases a flame kernel serving as a start of the flame propagation combustion.

As a result, since the air-fuel mixture is ignited by the plasma generated by the interaction between the spark discharge and the electric field, the ignition area increases, and two-dimensional ignition by only the spark plug 8 is transformed into three-dimensional ignition. Accordingly, an initial combustion becomes stable, the combustion rapidly propagates inside the combustion chamber 7 as an amount of the radicals increases, and the combustion spreads at a high combustion speed.

According to such a configuration, since the operation of the engine 100 is controlled so that the spark plug 8 causes spark discharge in the combustion chamber 7, the antenna 9 generates an electric field, and the spark discharge and the electric field are interacted with each other to generate plasma for igniting an air-fuel mixture, the operation condition of the engine 100 is detected, and high-frequency power supplied to the antenna is controlled according to the detected operation condition by the control program. In this control program, an intensity of electric field formed by the antenna 9 is set so as to become weaker than an electric field formed by the spark plug 8 when spark discharge is caused and is set to an intensity at which discharge inside the combustion chamber 7 by means of the antenna 9 is disabled. The intensity of the electric field is controlled to always become lower than the set electric field intensity by controlling the output of the magnetron 15.

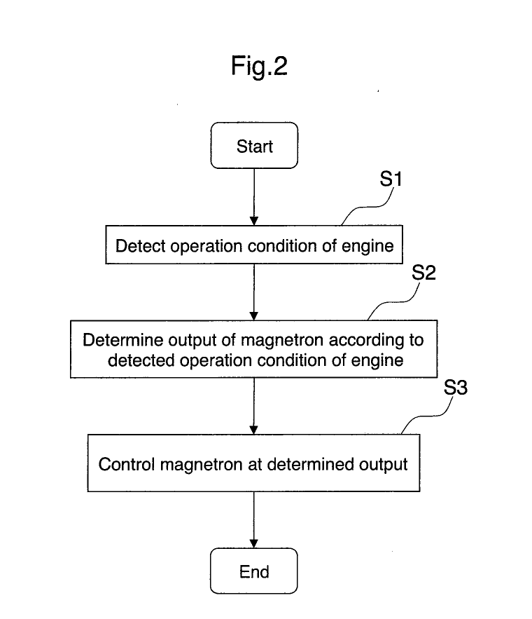

Hereinafter, a schematic procedure of controlling the internal combustion engine 100 will be described with reference to the flow chart illustrated in FIG. 2.

In step S1, the operation condition of the engine 100 is detected. The operation condition of the engine 100 is controlled, for example, based on the engine rotation speed and intake pressure. In this case, the operation condition is detected by combining a low load, a medium load, and a high load individually with a low rotation speed, a medium rotation speed, and a high rotation speed.

In step S2, the output of the magnetron 15 is determined based on the detected operation condition. The output of the magnetron 15 is set so as to be small when the operation condition of the engine 100 is at a low speed with a low load, and it is large at a high speed with a high load. In this case, an upper limit value is set to the output of the magnetron 15. This means that the output of the magnetron 15 is limited by the upper limit value so that the intensity of electric field formed in the combustion chamber 7 becomes smaller than the intensity of the electric field formed when the spark plug 8 performs spark discharge, and so that the output of the magnetron 15 becomes sufficient to form an electric field having an intensity at which discharge is disabled between the antenna 9 as a supply electrode of the electric field and an inner wall of the combustion chamber 7 serving as a ground electrode with respect to the supply electrode.

In step S3, the magnetron 15 is controlled so that it outputs the determined output.

Accordingly, although the output of the magnetron 15 is controlled according to the operation condition of the engine 100, since the upper limit of the output is regulated by the upper limit value, no discharge is caused between the antenna 9 and the inner wall of the combustion chamber 7. Accordingly, it is possible to ignite the air-fuel mixture at each set ignition timing and at a position of the spark plug 8 in each cylinder. As a result, the engine 100 can be operated in an excellent combustion condition by the spark discharge amplified by the electric field, i.e., by the spark discharge that is intensified by the plasma generated through the interaction between the electric field and the spark discharge.

It should be noted that the present invention is not limited to the first embodiment.

As the microwave generation device, a traveling-wave tube may be used instead of the magnetron as described above, and the microwave generation device may be further provided with a microwave oscillation circuit by semiconductor.

In addition, although the monopole antenna is described in the first embodiment, a horn antenna may also be used.

Further, it is also possible to use the center electrode of the spark plug 8 to function as an antenna so that it serves as a high-frequency wave feeder. In this case, since a temperature of the center electrode excessively increases when a high-frequency wave is continuously applied at a constant voltage to the center electrode, the voltage of the high-frequency wave is controlled to become lower than an upper limit temperature that is set according to a heat resistant temperature of the center electrode.

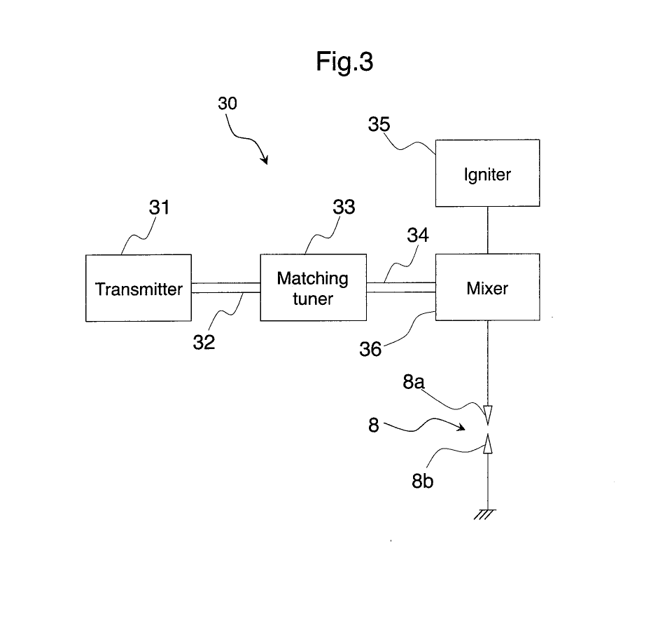

Meanwhile, the frequency of the electromagnetic wave of the electromagnetic wave generation device is not limited to a frequency band of microwaves, but it may be a frequency that is capable of generating an electric field in a spark discharge portion of the spark plug 8 to generate plasma. Accordingly, for, example, a configuration illustrated in FIG. 3 is preferable as the electromagnetic wave generation device.

An electromagnetic wave generation device 30 illustrated in FIG. 3 includes a transmitter 31 for oscillating an electromagnetic wave of, for example, 300 MHz, a matching tuner (or an antenna tuner) 33 that is connected to an output end of the transmitter 31 by a coaxial cable 32, and a mixer 36 that is connected to an output end of the matching tuner 33 by an unbalanced cable 34 and also connected to an igniter 35. In this example, a center electrode 8a of the spark plug 8 functions as an antenna that radiates an electromagnetic wave.

Accordingly, the mixer 36 applies the electromagnetic wave outputted by the transmitter 31, through the matching tuner 33, to the center electrode 8a of the spark plug 8, and applies an ignition signal from the igniter 35 to the center electrode 8a. The mixer 36 mixes the electromagnetic wave from the transmitter 31 with the ignition signal from the igniter 35.

In this example, an electric field is generated between the center electrode 8a and a ground electrode 8b by the electromagnetic wave from the transmitter 31. The generated electric field and the spark discharge generated between the center electrode 8a and the ground electrode 8b interact with each other to generate plasma which ignites the air-fuel mixture.

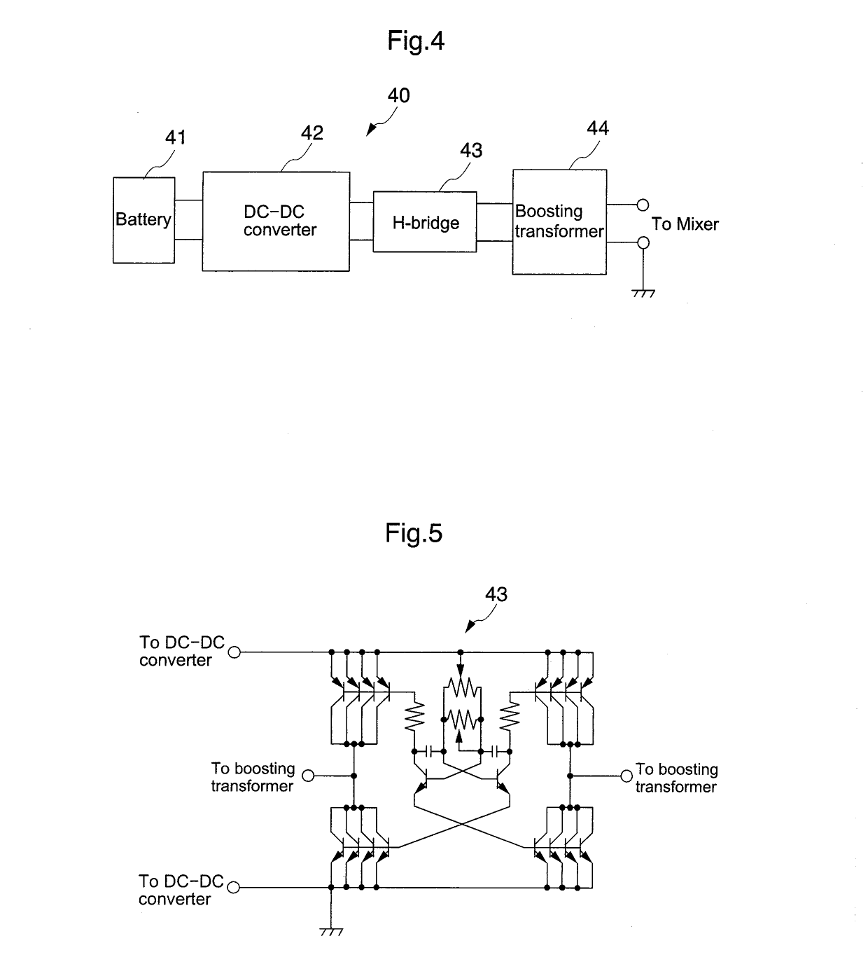

Instead of the electromagnetic wave generation device described above, it is also possible to use an alternating voltage generation device. An alternating voltage generation device 40 illustrated in FIG. 4 is configured to boost a voltage, e.g., about 12 V, of a battery 41 for a vehicle to 300 to 500 V by a DC-DC converter 42 which is a boosting circuit, then convert the boosted voltage, by an H-bridge circuit 43 exemplified in FIG. 5, into an alternating voltage having a frequency of about 1 MHz to 500 MHz, preferably 100 MHz, and further boost the resultant by a boosting transformer 44 to a voltage of about 4 kVp-p to 8 kVp-p.

In this alternating voltage generation device 40, assuming, for example, that the center electrode 8a and the ground electrode 8b of the spark plug 8 are a pair of electrodes for generating an electric field, a mixer is arranged between the boosting transformer 44 serving as an output terminal portion of the alternating voltage, and the igniter and the spark plug 8 as in the case of the electromagnetic wave generation device 30 described above. Then, by applying the alternating voltage having a high voltage between the center electrode 8a and the ground electrode 8b, an electric field whose polarities switch alternately at the above-mentioned frequency is generated in the gap of the spark plug 8, which is a discharge area. Accordingly, the electric field thus generated interacts with the spark discharge to generate plasma in the vicinity of the spark plug 8, thereby igniting the air-fuel mixture. It should be noted that, for such a configuration in which the pair of electrodes is formed of the center electrode 8a and the ground electrode 8b, a cylinder head, a cylinder block, or a piston may be used instead of the ground electrode 8b.

Other than using the center electrode 8a and the ground electrode 8b of the spark plug 8, the pair of electrodes may be structured such that electrodes are arranged in a position for holding the spark plug 8 therebetween. That is, a pair of electrodes is arranged opposed to each other with a predetermined distance therebetween. In this case, the pair of electrodes is arranged so that the spark plug 8 is positioned between the electrodes. In this case as well, it is also possible to use the ground electrode, a cylinder head, a cylinder block, or a piston instead of one of the electrodes.

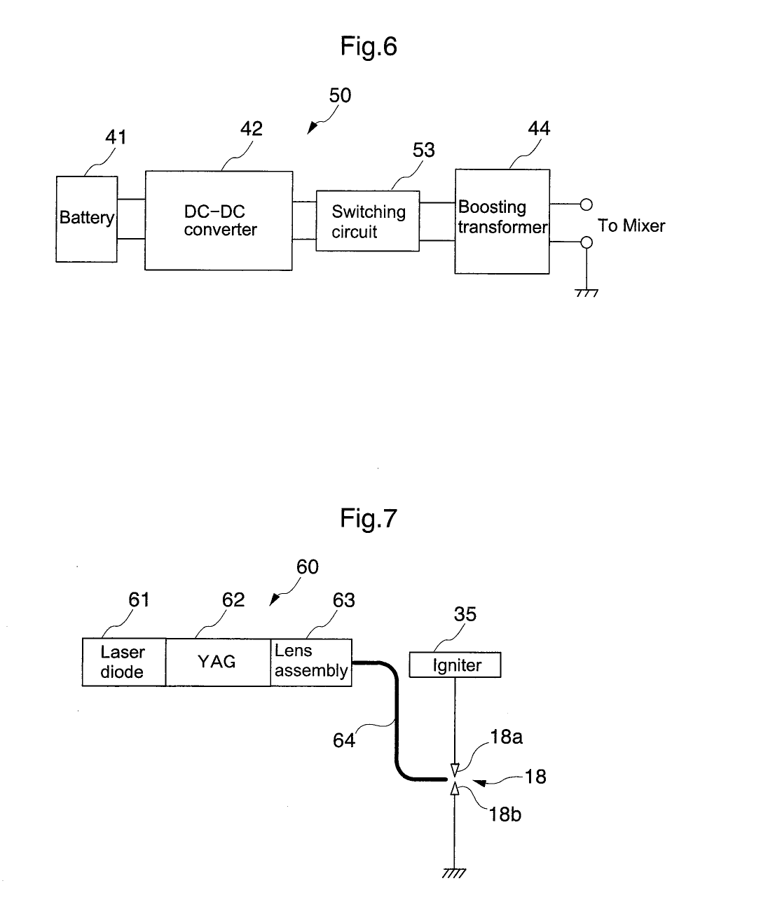

Instead of this alternating voltage generation device 40, a pulsation voltage generation device 50 may be used. Specifically, instead of applying an alternating voltage between the pair of electrodes, a pulsation voltage such as a pulse voltage is applied so that an electric field is generated between the pair of electrodes. In the pulsation voltage generation device 50 illustrated in FIG. 6, constitutional elements identical to those of the alternating voltage generation device 40 are denoted with identical reference numerals.

Similarly to the alternating voltage generation device 40, the pulsation voltage generation device 50 is configured to boost a direct current supplied from the battery 41 by the DC-DC converter 42, interrupt the direct current having a high voltage at predetermined intervals to form a pulsation voltage, boost the pulsation voltage by the boosting transformer 44, and apply the resultant to the pair of electrodes. In the case of the pulsation voltage generation device 50, a switching circuit 53 that performs periodical switching on and off is used instead of the H-bridge circuit 43.

By using such a pulsation generation circuit 50, it is also possible to generate an electric field between the pair of electrodes and obtain the same effect as that of the first embodiment.

Next, a second embodiment of the present invention will be described.

In the second embodiment, an electric field is generated in the combustion chamber by a laser oscillation device 60 which is an electromagnetic wave generation device constituting the electric field generation means.

The laser oscillation device 60 illustrated in FIG. 7 is configured by combining a laser diode 61, YAG (Yttrium, Aluminum, and Garnet) 62, and a lens assembly 63 including a cylindrical lens. This laser oscillation device 60 is, for example, of a pulse oscillation type and controls an average output, i.e., laser energy, by increasing or decreasing the number of pulses per second. The laser outputted from the laser oscillation device 60 is transmitted to the combustion chamber 7 through an optical fiber 64. In this case, the optical fiber 64 passes through a housing of the spark plug 8 and attached, at its front end, in a direction toward the gap between the center electrode 8a and the ground electrode 8b. The laser is applied to a position where the spark discharge occurs prior to the spark discharge.

The laser emitted from the optical fiber 64 is applied so as to focus on the gap between the center electrode 8a and the ground electrode 8b of the spark plug 8 which is an area where the electric field is generated and also an area where the spark discharge is caused. Accordingly, it is possible to generate the electric field in a predetermined position by directivity of the laser, and generate the plasma in a position most suitable for igniting the air-fuel mixture.

In such a configuration, similarly to the above embodiment, the output of the laser oscillation device 60 is controlled so that the laser energy is set to a level at which ignition is disabled when the electric field is generated by the laser, and the laser is directed into the combustion chamber 7. That is, the operation condition of the engine 100 is detected based on the engine rotation speed and the intake pressure, the output of the laser oscillation device 60 is determined based on the detected operation condition, and the laser oscillation device 60 is controlled so that its output becomes the determined output. The relationship between the operation condition of the engine 100 and the output thereof is set, similarly to the above embodiment, so that the output of the laser oscillation device 60 is small at a low rotation speed with a low load, and large at a high rotation speed with a high load. The control itself can be understood by replacing the magnetron with the laser oscillation device in the flowchart illustrated in FIG. 2.

In such output control of the laser oscillation device 60, an upper limit value is set to the output by which ignition becomes disabled in the operation condition at a high rotation speed and at a high load. By controlling the output of the laser oscillation device 60 in this manner, the laser energy interacts with the spark discharge to generate an electric field sufficient to generate plasma in individual operation conditions. Additionally, even if the laser oscillation device 60 applies the laser to a compressed air-fuel mixture, the laser energy thereof does not heat the air-fuel mixture to a temperature sufficient for ignition, and therefore ignition by the irradiation of laser is not caused.

Therefore, it is possible to ignite the air-fuel mixture at each set ignition timing and at a position of the spark plug 8 in each cylinder. As a result, the engine 100 can be operated in an excellent combustion condition by the spark discharge amplified by the electric field, i.e., by the spark discharge that is intensified by the plasma generated through the interaction between the electric field and the spark discharge.

The laser oscillation device is not limited to a solid-state laser oscillation device according to the above configuration, and may be of a well-known configuration for varying the laser energy, or of a continuous oscillation type.

Next, a description will be given of a spark plug in which a center electrode thereof is functioned as an antenna as described below instead of the antenna 9 of the first embodiment. When the spark plug according to this embodiment is used, the control program for adjusting the high-frequency wave power as described above is also applied. In order to suggest that the embodiment can be applied to various types of engines, hereinafter, a description will be given with reference to the drawings different from those used for the first embodiment.

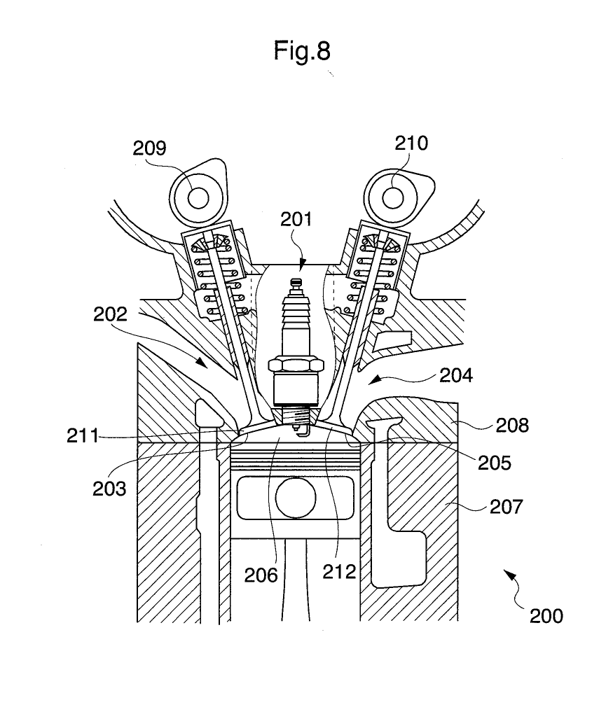

FIG. 8 illustrates an enlarged view of an attachment portion of a spark plug 201 of an engine 200 which is a spark-ignited internal combustion engine. The engine 200 is a double overhead camshaft (DOHC) engine having an opening 203 of an intake port 202 and an opening 205 of an exhaust port 204 arranged in a manner to oppose to each other with the spark plug 201 attached substantially in a center of a ceiling portion of a combustion chamber 206 interposed therebetween, and having openings in two locations in each cylinder. Specifically, according to the engine 200, cam shafts 209 and 210 are attached, respectively on intake and exhaust sides, to a cylinder head 208 that is attached to a cylinder block 207 and forms the ceiling portion of the combustion chamber 206. The intake port 202 of the cylinder head 208 is opened and closed by an intake valve 211 that is reciprocated by rotation of the cam shaft 209, and the exhaust port 204 is opened and closed by an exhaust valve 212 that is reciprocated by rotation of the cam shaft 210. The spark plug 201 is attached to the ceiling portion of the combustion chamber 206, and the intake port 202 is provided with a fuel injection valve (not illustrated) for generating an air-fuel mixture to be supplied to the combustion chamber 206. The engine 200 excluding the spark plug 201 may use a spark-ignited type which is known in this field.

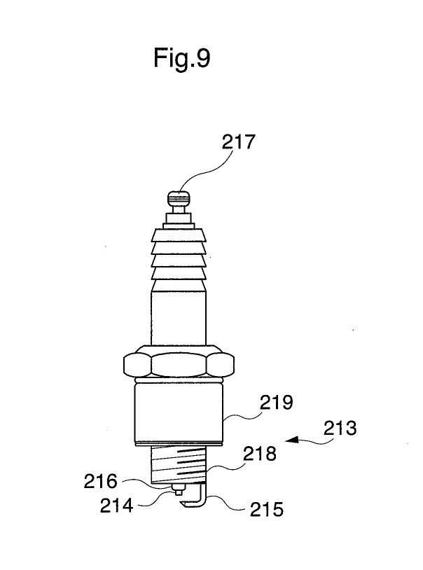

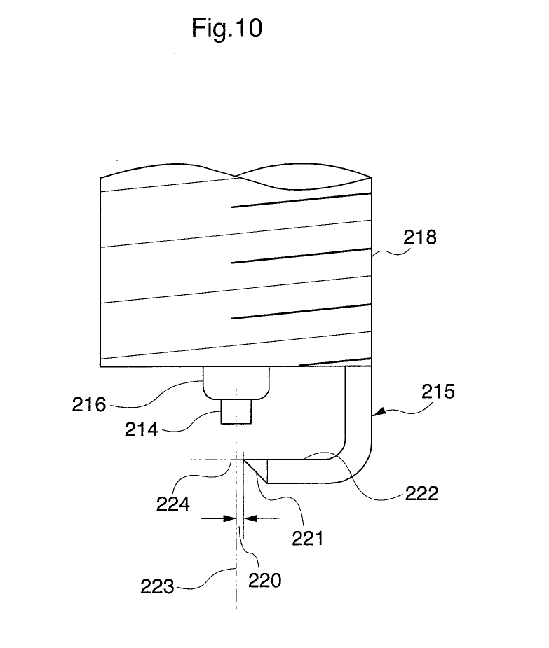

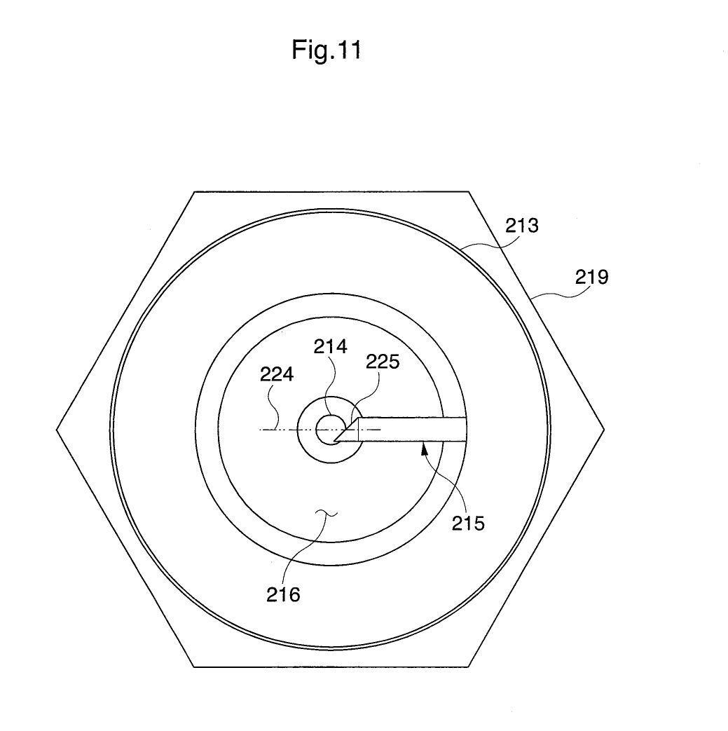

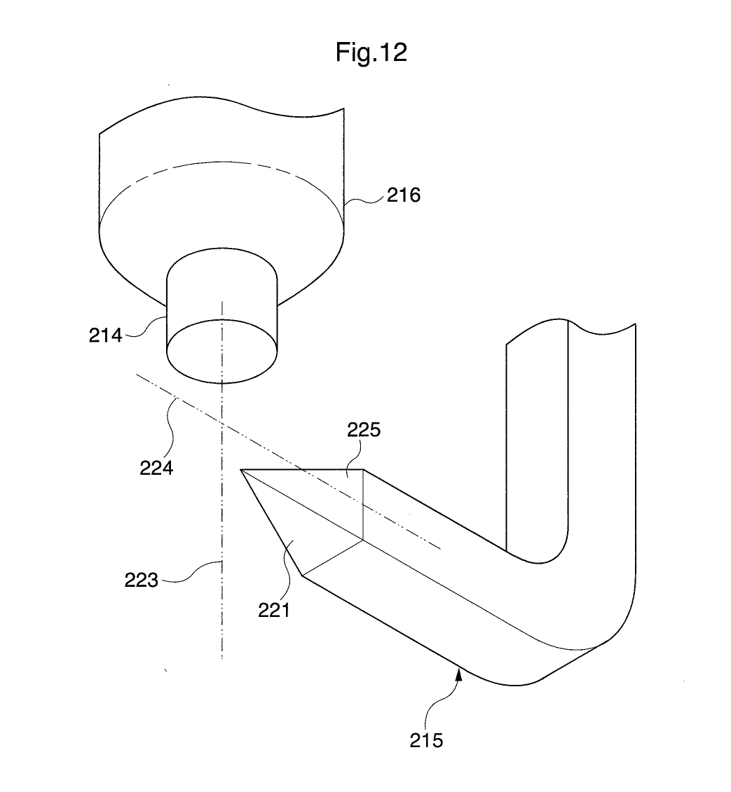

As illustrated in FIGS. 9 to 12, the spark plug 201 according to this embodiment includes a housing 213 made of a conductive material, a center electrode 214 insulated and attached inside the housing 213, and a ground electrode 215 provided at a lower end of the housing 213 away from the center electrode 214. Specifically, the spark plug 201 has a structure in which the housing 213 supports an insulator 216 having substantially a columnar shape, a connection terminal 217 attached to an upper end of the insulator 216 is electrically connected, by a center shaft (not illustrated), to the center electrode 214 protruding from the lower end of the housing 213, and the ground electrode 215 is integrally provided with the housing 213 at a position extending from the lower end of the housing 213 to a position facing a lower end of the center electrode 214. The insulator 216 insulates the center electrode 214 from the housing 213 which is an attachment portion to the engine 200, also insulates the center shaft which is a connecting member connecting the center electrode 214 to the connection terminal 217, and has a substantially cylindrical shape.

The housing 213 has a cylindrical shape including sufficient internal space for accommodating the insulator 216 therein and is made of a conductive material, for example, stainless steel. An upper end portion of the housing 213 is narrowed inwardly to make close contact with the insulator 216 to maintain airtightness. A male screw portion 218 is formed on an outer circumference in a portion lower than a center of the housing 213 in a longitudinal direction thereof for attachment to the cylinder head 208. In addition, a metallic shell 219 serving as an attachment seat portion for attaching is formed to have an outer diameter larger than that of the male screw portion 218 between the male screw portion 218 and the upper end portion.

The center electrode 214 is formed of, for example, a columnar metallic material, and has its lower end exposed from the insulator 216 and a lower end of the housing 213.

Contrary to such a center electrode 214, the ground electrode 215 is integrally formed with a lower end face of the housing 213, has substantially an L-shape in side view, and has a front end thereof extending to a position away from a center axis of the center electrode 214 with a gap 220 provided therebetween. Since the ground electrode 215 is formed integrally with the housing 213 in this manner, it is maintained at an identical electric potential as that of the housing 213 when used. The ground electrode 215 includes a specific surface 221 which is inclined in a direction away from the front end in front view. In other words, the specific surface 221 is an inclined surface provided on a lower surface of the ground electrode 215 on a side opposite to the center electrode 214, and has an inclination forming an acute angle with respect to an upper surface 222 of the ground electrode 215. Additionally, the ground electrode 215 has an inclined side surface diagonally crossing an extended axis line 224 of the ground electrode 215 which intersects a center axis line 223 of the center electrode 214. That is, the ground electrode 215 has, on a front side thereof, an inclined side surface 225 inclining toward a back side thereof.

According to such a configuration, the spark plug 201 is attached to each cylinder of the engine 200, performs spark discharge as its original function, and also functions as an antenna for generating plasma as will be described later. Specifically, when the air-fuel mixture in the combustion chamber 206 is ignited using the spark plug 201, the engine 200 generates plasma by interacting the spark discharge caused by the spark plug 201 with the electric field generated in the combustion chamber 206 so that the ignition area is enlarged as compared with that caused by ignition by the spark discharge without generating the plasma. For this reason, an ignition coil for spark discharge is connected to the center electrode 214 of the spark plug 201, as well as a microwave generation device (not illustrated), i.e., an electromagnetic wave generation device provided with a magnetron for outputting a microwave, i.e., an electromagnetic wave for generating an electric field. Accordingly, the microwave outputted from the magnetron is applied to the center electrode 214 of the spark plug 201 as described below.

As described above, the ground electrode 215 is spaced apart from the center axis line 223 of the center electrode 214 by an amount of the gap 220, and in addition, has the specific surface 221 that inclines with respect to the center axis line 223. Accordingly, when the microwave is applied to the center electrode 214, a direction of an electric field (line of electric force) generated between the center electrode 214 and the ground electrode 215 becomes perpendicular to the specific surface 221 on a surface of the specific surface 221. That is, when a state of the electric field generated between the center electrode 214 and the ground electrode 215 is represented by lines of electric force, there are many lines that perpendicularly intersect both a front end surface of the center electrode 214 and the specific surface 221 of the ground electrode 215, and connect the front end surface of the center electrode 214 and the specific surface 221 of the ground electrode 215 to each other in a curved shape. For this reason, a direction of electric field in the space between the center electrode 214 and the ground electrode 215 of the spark plug 201 is not aligned in a direction of the center axis line 223 of the center electrode 214, and is distorted. Consequently, since an intensity of a directional component of the electric field perpendicular to the spark discharge caused between the center electrode 214 and the ground electrode 215 becomes stronger, a flow of electrons caused by the spark discharge can be caused to meander efficiently, and therefore an amount of generated plasma increases as compared with a case where the specific surface 221 is not provided. Also, since a direction of electric field also becomes perpendicular, in a similar manner, to the inclined side surface 225 which is formed on a front side of the ground electrode 215, an intensity of a directional component of the electric field perpendicular to the spark discharge in a direction toward the inclined side surface 225 becomes stronger, and generation of plasma further increases.

When ignition is performed, the spark plug 201 is caused to produce spark discharge by an ignition coil (not illustrated), an electric field is generated by a microwave almost at the same time as the start of the spark discharge, immediately after the start of the spark discharge, or immediately before the start of the spark discharge, plasma is generated by causing the spark discharge to interact with the electric field, and thus the air-fuel mixture in the combustion chamber 206 is rapidly combusted. It is preferable that the timing of immediately after the start of the spark discharge coincide, at the latest, with a start of inductive discharge that forms the spark discharge.

Specifically, the spark discharge by the spark plug 201 generates plasma in the electric field, a flame kernel serving as a start of flame propagation combustion by igniting the air-fuel mixture by the plasma becomes larger as compared with the ignition with only the spark discharge, and the combustion is facilitated by generation of a large amount of radicals in the combustion chamber 206.

This is because flows of electrons by the spark discharge and ions or radicals generated by the spark discharge have a longer path by vibration and meandering under the influence of the electric field, and a frequency of collision with surrounding water molecules or nitrogen molecules drastically increases. The water molecules or nitrogen molecules against which the ions or radicals have collided transform into OH radicals or N radicals, and surrounding gasses against which the ions or radicals have collided transform into an ionization state, i.e., a plasma state, which drastically increases an ignition area of the air-fuel mixture and also increases a flame kernel serving as a start of flame propagation combustion.

As a result, since the air-fuel mixture is ignited by the plasma generated by the interaction between the spark discharge and the electric field, the ignition area increases, and two-dimensional ignition by only the spark plug 201 is transformed into three-dimensional ignition. Accordingly, initial combustion becomes stable, the combustion rapidly propagates inside the combustion chamber 206 as an amount of the radicals increases, and the combustion spreads at a high combustion speed.

Further, the ground electrode 215 includes the specific surface 221 and the inclined side surface 225, and thereby a direction of the electric field becomes different from a direction of the spark discharge. As a result, a force is exerted on electrons caused by the spark discharge in a direction different from the flow of the electrons, the flow of electrons caused by the spark discharge can be caused to meander efficiently, and therefore an amount of plasma can be increased. Since the intensity of the electric field can be adjusted by controlling the direction thereof, the output of the magnetron that outputs the microwave can be reduced. As a result, power consumption for generating the plasma can be reduced. In addition, by reducing the output of the magnetron, it is possible to prevent discharge from being caused prior to the spark discharge between the center electrode and the ground electrode.

It should be noted that the spark plug according to the present invention is not limited to the third embodiment.

As described in the third embodiment, the spark plug according to the present invention is characterized by providing, in the front end portion of the ground electrode 215, the specific surface which deforms, in the space between the center electrode 214 and the ground electrode 215, the electric field formed by the microwave emitted from the center electrode 214. However, the shape of the specific surface is not limited to that in the third embodiment. That is, the specific surface may be provided based on the fact that the direction of the electric field becomes perpendicular to a metallic surface. Although the specific surface 221 is formed of a flat surface in the third embodiment, the specific surface 221 may be a curved surface such as a concave surface or a convex surface, or a wavy curved surface with continuous concave and convex surfaces.

In the third embodiment, although the inclined side surface is provided only on the front side of the ground electrode 215, it may be also provided on the rear side thereof. That is, the ground electrode may be provided with an inclined surface that inclines in a direction toward a point where both side surfaces come closer to each other, and provided with a specific surface on a bottom surface. As a result, the front end portion of the ground electrode which opposes the center electrode becomes an apical end of a triangular pyramid shape formed of three surfaces that converge to a point.

In the above description, as the means for outputting microwaves, a traveling-wave tube may be used instead of the magnetron as described above, and may be further provided with a microwave oscillation circuit by semiconductor.

Further, in the case where the center electrode of the spark plug 201 is caused to function as an antenna, since a temperature of the center electrode excessively increases when a high-frequency wave is continuously applied at a constant voltage to the center electrode, the voltage of the high-frequency wave is controlled to become lower than an upper limit temperature that is set according to a heat resistant temperature of the center electrode.

In addition to the above, it is also possible to connect the electromagnetic wave generation device 30, the alternating voltage generation device 40, or the pulsation voltage generation device 50 illustrated in FIGS. 3 to 6 to the spark plug 201 as the electric field generation means for generating an electric field.

In addition, the specific configuration of each of the portions is not limited to the embodiments described above, but can be variously modified without departing the gist of the present invention.

### INDUSTRIAL APPLICABILITY

As an application example of the present invention, the present invention may be applied to a spark-ignited internal combustion engine that requires for ignition, gasoline or liquefied natural gas as a fuel, and spark discharge by the spark plug.

### DESCRIPTION OF REFERENCE SIGNS

6: Electronic control device
7: Combustion chamber
8: Spark plug
15: Magnetron
18: Central processing unit
19: Memory device
20: Input interface
21: Output interface
9: Antenna
201: Spark plug
206: Combustion chamber
213: Housing
214: Center electrode
215: Ground electrode
221: Specific surface
223: Center axis line
224: Extended axis line
225: Inclined side surface

1. A control method for a spark-ignited internal combustion engine, comprising:
generating plasma by interacting an electric field generated in a combustion chamber by electric field generation means with spark discharge caused by a spark plug; and
igniting an air-fuel mixture, wherein
the electric field generated by the electric field generation means is set to an intensity weaker than that of an electric field generated by the spark plug when the spark discharge is caused and is set to an intensity at which discharge into the combustion chamber is disabled.

2. The control method for a spark-ignited internal combustion engine according to claim 1, wherein the electric field generation means is a magnetron.

3. The control method for a spark-ignited internal combustion engine according to claim 1, wherein the electric field generation means is an alternating voltage generation device.

4. A control method for a spark-ignited internal combustion engine, comprising:
generating plasma by interacting an electric field generated in a combustion chamber by laser with spark discharge caused by a spark plug; and
igniting an air-fuel mixture, wherein
when the electric field is generated by the laser, energy of the laser is set to a level at which ignition is disabled.

5. The control method for a spark-ignited internal combustion engine according to claim 4, wherein the laser is generated by a laser oscillation device capable of changing an output.

6. A spark plug for a spark-ignited internal combustion engine, comprising:
a center electrode electrically insulated and attached in a housing; and
a ground electrode arranged at a lower end of the housing away from the center electrode, wherein
plasma is generated by interacting spark discharge caused between the center electrode and the ground electrode with an electric field generated in a combustion chamber, and an air-fuel mixture is ignited, the ground electrode is disposed so that a front end thereof is positioned away from a center axis of the center electrode, and the ground electrode includes a specific surface that forms a direction of the electric field in a direction intersecting a direction of the spark discharge that is caused between the center electrode and the ground electrode.

7. The spark plug for a spark-ignited internal combustion engine according to claim 6, wherein the specific surface is an inclined surface provided on a lower surface of the ground electrode on a side opposite to the center electrode.

8. The spark plug for a spark-ignited internal combustion engine according to claim 7, wherein the ground electrode includes an inclined side surface that obliquely crosses an extended axial line of the ground electrode intersecting the center axis of the center electrode.
